(19) United States
(12) Patent Application Publication
(10) Pub. No.: US 2009/0067531 A1
(43) Pub. Date: Mar. 12, 2009

(54) METHOD FOR REPORTING CHANNEL INFORMATION IN MULTIPLE ANTENNA SYSTEM

(75) Inventors: Wook Bong Lee, Seoul (KR); Bin Chul Ihm, Anyang-si (KR); Moon II Lee, Seoul (KR); Hyun Soo Ko, Seongnam-si (KR); Jin Young Chun, Yongin-si (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG Electronics Inc.

(21) Appl. No.: 11/925,500

(22) Filed: Oct. 26, 2007

Related U.S. Application Data
(60) Provisional application No. 60/863,111, filed on Oct. 26, 2006.

(30) Foreign Application Priority Data
Dec. 28, 2006 (KR) 10-2006-0135960

(51) Int. Cl. H04B 7/02

(52) U.S. Cl. 375/267

(57) ABSTRACT

There is provided a method of reporting downlink channel information to a base station in a multiple antenna system. The method includes reporting a single rank for overall subband, the overall subband comprising a plurality of subbands and reporting a CQI for the single rank for at least one subband. Radio resources required for reporting channel information can be reduced and signaling overheads can be minimized.

### CROSS-REFERENCE TO RELATED APPLICATIONS

This application claims the benefit of priority of U.S. Provisional application Ser. No. 60/863,111 filed on Oct. 26, 2006 and Korean Patent Application No. 10-2006-0135960 filed on Dec. 28, 2006, which are incorporated by reference in their entirety herein.

### BACKGROUND

1. Technical Field

The present invention relates to wireless communication, and more specifically, to a method of reporting downlink channel information in a multiple antenna system.

2. Related Art

Owing to generalization of information communication services, advent of a variety of multimedia services, appearance of high quality services, and the like, the demand for communication services are rapidly increased. Researches on a variety of wireless communication techniques are in progress in various fields to satisfy such demand.

A multiple-input multiple-output (MIMO) technique capable of simultaneously transmitting multiple spatial streams is required to obtain high spectral efficiency. The MIMO technique employs a multiple transmit antenna and one or more receiving antennas.

MIMO channels provided by a multiple antenna can be decomposed into multiple independent channels. If the number of transmit antennas is Nt and the number of receiving antennas is Nr, the number of independent channels Ni is Ni≦min{Nt, Nr}. Each of the independent channels can be referred to as a spatial layer.

A rank is the number of non-zero eigenvalues of a MIMO channel matrix, which can be defined as the number of spatial streams that can be multiplexed. The rank is the same as the number of independent channels. If the rank is one, one stream can be transmitted on one spatial layer, and if the rank is two, two independent streams can be simultaneously transmitted on two spatial layers. If the rank is K, K independent streams having different rates can be transmitted on each spatial layer.

For a 4×4 MIMO system, maximum four ranks (four MIMO layers) are possible. However, transmission using a maximum rank is not always desirable. A MIMO channel can limit a rank used for transmission. Although high rank transmission is superior to low rank transmission in the aspect of a rate, the low rank transmission is desirable for a poor channel condition.

In order to obtain gain for multiple antennas, it is needed to design a MIMO system that utilizes channel dependent feedback of a user equipment to tune downlink transmission scheme. For this purpose, it is required that the user equipment feeds back channel information.

If the user equipment reports channel information for every resource block, the best flexibility can be obtained. However, if the channel information for every resource block is reported, high signaling overhead may be caused.

There is a need for a method which can reduce signaling overhead due to channel information in the MIMO system.

### SUMMARY

An object of the invention is to provide a method for reporting channel information to reduce signaling overhead in a multiple antenna system.

In one aspect, there is provided a method of reporting downlink channel information to a base station in a multiple antenna system. The method includes reporting a single rank for overall subband, the overall subband comprising a plurality of subbands and reporting a CQI for the single rank for at least one subband.

In another aspect, there is provided a method of reporting downlink channel information to a base station in a multiple antenna system. The method includes selecting a single rank for overall subband, the overall subband comprising a plurality of subbands, reporting the single rank and reporting a CQI for the single rank for each subband.

In still another aspect, there is provided a method for transmitting downlink data in a multiple antenna system. The method includes receiving a single rank for overall subband, receiving a CQI for the single rank, transmitting a rank determined using the single rank through a downlink control channel, allocating at least one subband using the rank and the CQI and transmitting the downlink data through the allocated subband.

### BRIEF DESCRIPTION OF THE DRAWINGS

FIG. 1 is a block diagram showing a transmitter according to an embodiment of the invention.

FIG. 2 is a block diagram showing a receiver according to an embodiment of the invention.

FIG. 3 is a view showing the resource configuration of a system based on OFDMA.

FIG. 4 is a flowchart illustrating a method of reporting channel information according to an embodiment of the present invention.

FIG. 5 is an exemplary view illustrating a method of reporting channel information according to an embodiment of the present invention.

### DESCRIPTION OF EXEMPLARY EMBODIMENTS

The technique described below can be used in a variety of communication systems including a code division multiple access (CDMA) system, a wideband CDMA (WCDMA) system, a frequency division multiple access (FDMA) system, an orthogonal frequency division multiplexing (OFDM)/orthogonal frequency division multiple access (OFDMA) system, and the like. OFDM is a multiple carrier modulation technique for efficiently dividing an overall system bandwidth into a plurality of orthogonal subbands. A subband can be referred to as a tone, subcarriers, a subchannel or the like.

The communication system can be a multiple-input multiple-output (MIMO) system or a multiple-input single-output (MISO) system. The MIMO system uses a plurality of transmit antennas and a plurality of receiving antennas. The MISO system uses a plurality of transmit antennas and a single receiving antenna.

A base station (hereinafter, referred to as BS) is a fixed station communicating with a user equipment, which can be referred to as another terminology, such as a node-B, a base transceiver system (BTS), a access point or the like. The user equipment (hereinafter, referred to as UE) can be fixed or mobile and can be referred to as another terminology, such as a mobile station (MS), a user terminal (UT), a subscriber station (SS), a wireless device or the like.

A downlink means a communication from the BS to the UE, and an uplink means a communication from the UE to the BS. In the downlink, a transmitter can be a part of the BS, and a receiver can be a part of the UE. In the uplink, the transmitter can be a part of the UE, and the receiver can be a part of the BS.

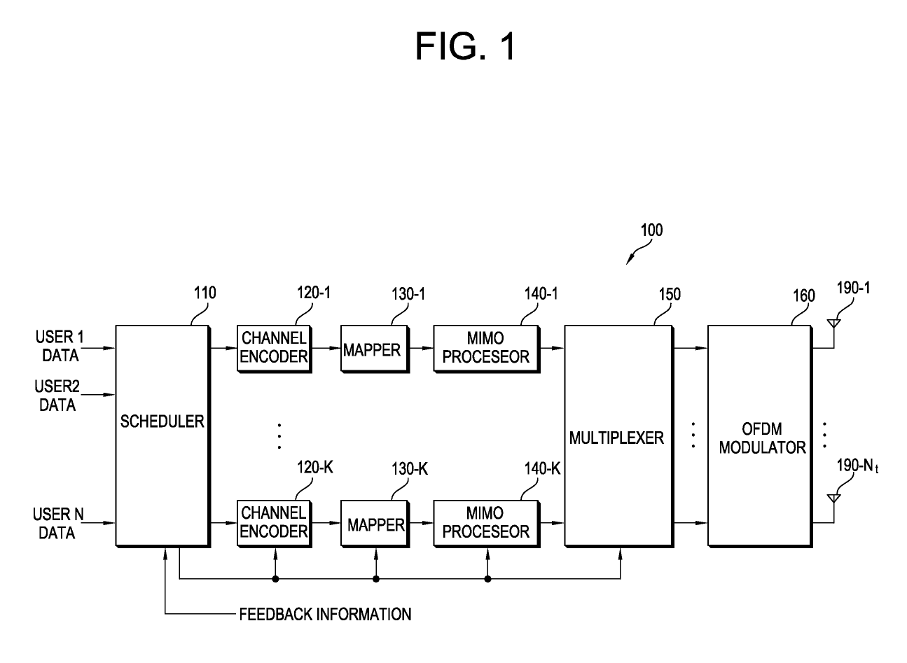

FIG. 1 is a block diagram showing a transmitter according to an embodiment of the invention.

Referring to FIG. 1, a transmitter 100 includes a scheduler 110, channel encoders 120-1 to 120-K, mappers 130-1 to 130-K, MIMO processors 140-1 to 140-K and a multiplexer 150. The transmitter 100 also includes Nt (Nt>1) transmit antennas 190-1 to 190-Nt.

The scheduler 110 receives data from N users and outputs K streams to be transmitted at one time. The scheduler 110 selects modulation and coding scheme (MCS) such as a code rate and modulation scheme and outputs the selected MCS to the channel encoders 120-1 to 120-K, the mappers 130-1 to 130-K. The scheduler 110 selects MIMO scheme and outputs the selected MIMO scheme to the MIMO processors 140-1 to 140-K.

Each of the channel encoders 120-1 to 120-K encodes input streams in a predetermined coding scheme and forms coded data. Each of the mappers 130-1 to 130-K maps the coded data to a data symbol on signal constellation. Any kind of modulation scheme can be used, including m-Phase Shift Keying (m-PSK) and m-Quadrature Amplitude Modulation (m-QAM). For example, the m-PSK can be binary-PSK (BPSK), quadrature-PSK (QPSK), or 8-PSK, and the m-QAM can be 16-QAM, 64-QAM, or 256-QAM.

Each of the MIMO processors 140-1 to 140-K processes the data symbol in the MIMO scheme in accordance with the multiple transmit antennas 190-1 to 190-Nt. For example, the MIMO processors 140-1 to 140-K can perform codebook-based preceding.

The multiplexer 150 allocates an input symbol to an appropriate a sub-carrier and multiplexes input symbols for multiple users. An OFDM modulator 160 performs OFDM modulation on the input symbols and outputs an OFDM symbol. The OFDM modulator 160 can perform inverse fast Fourier transform (IFFT) on the input symbols and additionally insert a cyclic prefix (CP) after performing the IFFT. The OFDM symbol is transmitted through each of the transmit antennas 190-1 to 190-Nt.

The transmitter 100 can operate in two modes. The one is a single codeword mode and the other is a multiple codeword mode. In the single codeword mode, signals transmitted through MIMO channels have the same data rate. In the multiple codeword mode, data transmitted through the MIMO channels are independently encoded, so that transmission signals may have different data rates.

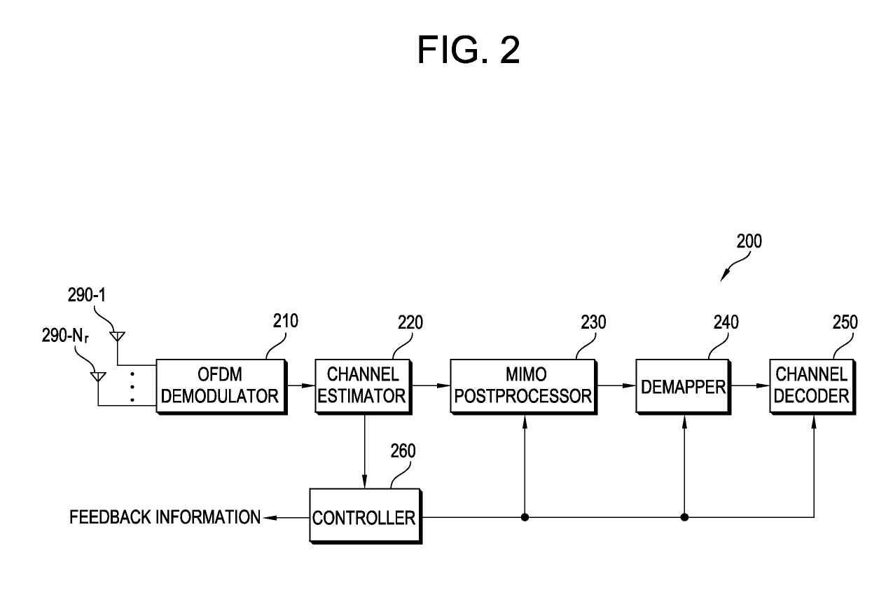

FIG. 2 is a block diagram showing a receiver according to an embodiment of the invention.

Referring to FIG. 2, a receiver 200 includes an OFDM demodulator 210, a demapper 240, a channel decoder 250, and a controller 260.

The OFDM demodulator 210 performs fast Fourier transform (FFT) on signals received from receiving antennas 290-1 to 290-Nr. A channel estimator 220 estimates a channel, and a MIMO post-processor 230 performs a post-process corresponding to the MIMO processors 140-1 to 140-K. The demapper 240 demaps input symbols into coded data, and the channel decoder 250 decodes the coded data and restores original data. The controller 260 creates appropriate feedback information and feeds back the created feedback information to the transmitter 100 through the estimated channel or the like.

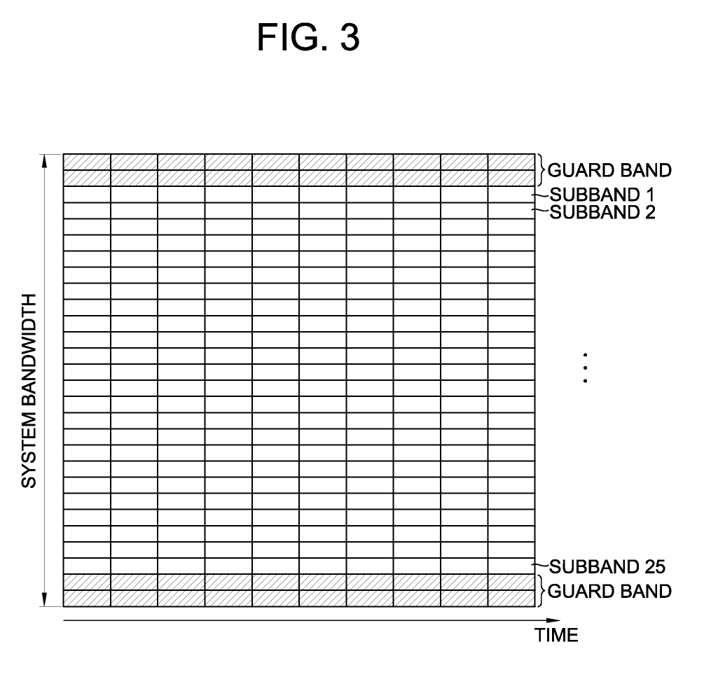

FIG. 3 is a view showing the resource configuration of a system based on OFDMA.

Referring to FIG. 3, a system bandwidth is divided into a plurality of subbands. A subband is a unit of frequency resources allocated to each UE. The subband also can be called as a resource block or a subchannel. Each UE can be allocated with at least one subband.

It is assumed that the system bandwidth is divided into 512 subcarriers, i.e., the size of FFT is 512. A subband includes twelve subcarrier and total number of the subbands is 25 (L=25). Guard bands are provided at both ends of the system bandwidth.

A BS should know downlink channel information to select K UEs from N UEs (K<N), where K and N are integer. The BS allocates at least one subband to a user using the channel information reported from the UE. The downlink channel information may include a channel quality indication (CQI), a rank and a preceding matrix index (PMI). Base on the channel information, the BS allocates radio resources to each UE based on an appropriate criterion.

Since the minimum transmission unit that can be allocated to each UE is the subband, all of channel information needs to be calculated and transmitted in correspondence with the subband. If the number of UEs in a sector or a cell is small, a plurality of subbands can be allocated to a UE.

If M subbands are allocated to a UE, the BS should inform the UE of information on resource allocation and selected MCS and MIMO scheme through a downlink channel. When L subbands are selected for the UE, the BS should transmit information for L selected subbands on a downlink control channel to the UE. This causes heavy traffic load for downlink control signals.

An appropriate MCS and a rank may be different in each subband. If only the MCS is different and M subbands are allocated to a UE, an average CQI of the M subbands can be calculated as shown

$$CQI = exp ( \frac{1}{M} {\sum }_{i = 1}^{M} log ( 1 + {CQI}_{i} ) ) - 1 \qquad [ Mathematical expression 1 ]$$

where a CQIᵢ is a CQI of the i-th subband.

When a rank of each subband is different, an average CQI cannot be calculated using above equation. If the UE transmits CQIs for every rank as feedback information, the BS can transmit data through the best rank. However, the amount of feedback information is increased.

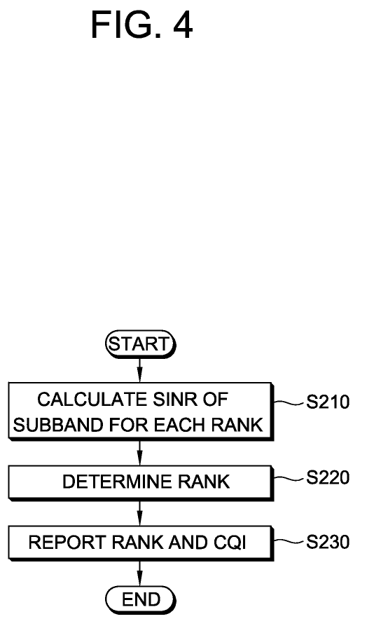

FIG. 4 is a flowchart illustrating a method of reporting channel information according to an embodiment of the present invention.

Referring to FIG. 4, a signal-to-interference plus noise ratio (SINR) of a subband is calculated for each rank S220.

A single rank is determined for overall subbands based on a specific criterion S230.

A UE selects the single rank for overall subbands based on the specific criterion and reports the single rank and a CQI corresponding to the single rank S230. If codebook-based preceding is used, the UE can report a PMI together with the single rank and the CQI.

The UE can reduce feedback overheads by reporting only the single rank selected for overall subbands to the BS. The BS receives the single rank and the CQI corresponding to the single rank. And the BS allocates at least one subband to the UE for downlink data.

The UE can calculate a metric for each rank in order to determine the single rank. The metric can be calculated using SINR calculated for each subband and each rank.

In one embodiment, a throughput or a capacity of each rank is calculated as a metric for determining a single rank. A rank having the largest value is selected as the single rank.

In the case of a single codeword mode, a single rank can be determined as shown

maxᵣ(max_{b}(ƒ(SIN R_{r,b}))) [Mathematical expression 2]

where b is the index of a subband, r is the index of a rank and SIN R_{r,b} is SIN R of the r-th rank and b-th subband. f( ) is a function of SINR, representing a capacity or a throughput, and its value becomes a metric.

By comparing with values of the metric for every rank, a rank having the largest value of the metric is selected as the single rank.

For example, it is assumed that there is a system having eight subbands and two ranks, i.e., rank 1 and rank 2. Metrics are as shown in Table 1.

TABLE 1

| | Rank 1 | Rank 2 |
|---|---|---|
| Subband 1 | 1.0 | 1.8 |
| Subband 2 | 1.2 | 2.4 |
| Subband 3 | 0.4 | 1.3 |
| Subband 4 | 1.1 | 0.8 |
| Subband 5 | 2.5 | 1.4 |
| Subband 6 | 1.8 | 1.3 |
| Subband 7 | 0.9 | 0.7 |
| Subband 8 | 0.6 | 1.0 |

The largest value of the metric of rank 1 is 2.5 of subband 5, and the largest value of the metric of rank 2 is 2.4 of subband 2. Accordingly, a single rank is determined as rank 1, and a corresponding CQI, a codebook index or a PMI is fed back.

In the case of a multiple codeword mode, a single rank can be determined as shown

$${max}_{r} ( {max}_{b} ( {\sum }_{i = 1}^{Cr} f ( {SINR}_{r , b , i} ) ) ) ) \qquad [ Mathematical expression 3 ]$$

where Cᵣ is the number of codewords of rank r and SIN R_{r,b,i} is SIN R of the r-th rank, b-th subband, and i-th codeword. By comparing the sum of Cᵣ metrics for every ranks, a rank having the largest sum is selected as a single rank.

For example, it is assumed that there is a system having eight subbands and two ranks, i.e., rank 1 and rank 2. Metrics are as shown in Table 2.

TABLE 2

| | |
|---|---|
| Rank 1 | Rank 2 |

| | | | |
|---|---|---|---|
| Subband 1 | 1.0 | 0.8 | 1.0 |
| Subband 2 | 1.2 | 1.0 | 1.4 |
| Subband 3 | 0.4 | 0.8 | 0.5 |
| Subband 4 | 1.1 | 0.6 | 0.2 |
| Subband 5 | 2.5 | 0.7 | 0.7 |
| Subband 6 | 1.8 | 0.6 | 0.7 |
| Subband 7 | 0.9 | 0.4 | 0.3 |
| Subband 8 | 0.6 | 0.5 | 0.5 |

C₁ of rank 1 is one, and C₂ of rank 2 is two. The largest sum of the metric of rank 1 is 2.5 of subband 5, and the largest sum of the metric of rank 2 is 2.4 of subband 2. Accordingly, a single rank is determined as rank 1, and a corresponding CQI, a codebook index or a PMI is fed back.

In another embodiment, a throughput sum (or a capacity sum) of subbands having J best throughputs (or capacities) is calculated for each rank as a criterion for determining a single rank. A rank having the largest throughput sum (or capacity sum) can be selected as the single rank. J is a parameter determined depending on the number of subbands, a feedback method, a MIMO scheme and the like. J can be a value previously stored in a UE's memory. Or, J can be a value previously known to both a BS and a UE or can be transmitted by the BS to the UE.

In the case of a single codeword mode, a single rank can be determined as shown

$${max}_{r} ( {\sum }_{h = 1}^{J} order ( f ( {SINR}_{r , b} ) ) ) \qquad [ Mathematical expression 4 ]$$

where order( ) is a function for sorting internal values in descending order.

Metrics are calculated for each rank and sorted in descending order for each subband and best J subbands of each rank are summed. By comparing with metric sums of every ranks, a rank having the largest metric sum is selected as the single rank.

For example, it is assumed that there is a system having eight subbands and two ranks, i.e., rank 1 and rank 2. Metrics are as shown in Table 3.

TABLE 3

| | Rank 1 | Rank 2 |
|---|---|---|
| Subband 1 | 1.0 | 1.8 |
| Subband 2 | 1.2 | 2.4 |
| Subband 3 | 0.4 | 1.3 |
| Subband 4 | 1.1 | 0.8 |
| Subband 5 | 2.5 | 1.4 |
| Subband 6 | 1.8 | 1.3 |
| Subband 7 | 0.9 | 0.7 |
| Subband 8 | 0.6 | 1.0 |

It is assumed that J is four. In Table 3, the metric sum of best four metrics (subband 2, 4, 5, and 6) of rank 1 is 6.6, and the metric sum of best four metrics (subband 1, 2, 3, and 5) of rank 2 is 6.9. Accordingly, the single rank is determined as rank 2, and a corresponding CQI, a codebook index or a PMI is fed back.

In the case of a multiple codeword mode, a single rank can be determined as shown

$${max}_{r} ( {\sum }_{h = 1}^{J} order ( {\sum }_{i = 1}^{Cr} f ( {SINR}_{r , b , i} ) ) ) \qquad [ Mathematical expression 5 ]$$

where Cᵣ is the number of codewords of rank r.

A sum of Cᵣ metrics is calculated for every subbands of each rank and sorted in descending order in each subband. Best J metric sums of each rank are summed. By comparing with metric sums of every ranks, a rank having the largest metric sum is selected as the single rank.

For example, it is assumed that there is a system having eight subbands and two ranks, i.e., rank 1 and rank 2. Metrics are as shown in Table 4.

TABLE 4

| | |
|---|---|
| Rank 1 | Rank 2 |

| | | | |
|---|---|---|---|
| Subband 1 | 1.0 | 0.8 | 1.0 |
| Subband 2 | 1.2 | 1.0 | 1.4 |
| Subband 3 | 0.4 | 0.8 | 0.5 |
| Subband 4 | 1.1 | 0.6 | 0.2 |
| Subband 5 | 2.5 | 0.7 | 0.7 |
| Subband 6 | 1.8 | 0.6 | 0.7 |
| Subband 7 | 0.9 | 0.4 | 0.3 |
| Subband 8 | 0.6 | 0.5 | 0.5 |

C₁ of rank 1 is one, and C₂ of rank 2 is two. It is assumed that J is four. In Table 4, the sum of largest four metric (subband 2, 4, 5, and 6) of rank 1 is 6.6, and the sum of largest four metric sums (subband 1, 2, 3, and 5) of rank 2 is 6.9. Accordingly, the single rank is determined as rank 2.

Even in the case of feeding back all CQIs of every subbands, feeding back CQIs of some subbands, feeding back CQIs using discrete cosine transform (DCT) or the like, a single rank for overall subbands can be determined. A UE obtains a CQI of each subband for the single rank and reports the single rank and the CQI to the BS. The UE can report CQIs for every subbands or CQIs for some subbands. When the number of overall subbands is twelve, the UE obtains a CQI for each of the twelve subbands and can report the twelve CQIs. Alternatively, the UE can select three subbands having best CQIs out of the twelve subbands and report the three CQIs. For the other nine subbands, an average CQI of the nine subbands can be reported.

Hereinafter, A method of determining a single rank when CQIs of best M subbands among L subbands (M<L) are reported and an average CQI is reported for the other subbands is described. A value M is a value previously known to both a BS and a UE or can be transmitted by the BS to the UE.

When a throughput (or a capacity) of each rank is calculated as a criterion for determining a single rank, and a rank having the largest value is selected as the single rank, the rank can be determined using mathematical expression 2 in a single codeword mode or mathematical expression 3 in a multiple codeword mode.

When a sum of J throughputs (or capacities) of each rank is taken as a criterion for determining a single rank, if M is larger than J, the single rank can be determined using mathematical expression 4 in a single codeword mode and mathematical expression 5 in a multiple codeword mode.

If M is smaller than J, the single rank in a single codeword mode can be determined as shown

$${max}_{r} ( {\sum }_{b = 1}^{M} order ( f ( {SINR}_{r , b} ) ) ) \qquad [ Mathematical expression 6 ]$$

For example, it is assumed that there is a system having eight subbands and two ranks, i.e., rank 1 and rank 2. Metrics are as shown in Table 5.

TABLE 5

| | Rank 1 | Rank 2 |
|---|---|---|
| Subband 1 | 1.0 | 1.8 |
| Subband 2 | 1.2 | 2.4 |
| Subband 3 | 0.4 | 1.3 |
| Subband 4 | 1.1 | 0.8 |
| Subband 5 | 2.5 | 1.4 |
| Subband 6 | 1.8 | 1.3 |
| Subband 7 | 0.9 | 0.7 |
| Subband 8 | 0.6 | 1.0 |

It is assumed that J is four and M is two. Since M is smaller than J, the rank is determined based on a sum of M metrics. That is, the sum of two best metrics (subbands 5 and 6) of rank 1 is 4.3, and the sum of two best metrics (subbands 1 and 2) of rank 2 is 4.2. Accordingly, the single rank is determined as rank 1.

If M is smaller than J, a single rank in a multiple codeword mode can be determined as shown

$${max}_{r} ( {\sum }_{h = 1}^{M} order ( {\sum }_{i = 1}^{Cr} f ( {SINR}_{r , b , i} ) ) ) \qquad [ Mathematical expression 7 ]$$

For example, it is assumed that there is a system having eight subbands and two ranks, i.e., rank 1 and rank 2. Metrics are as shown in Table 6.

TABLE 6

| | |
|---|---|
| Rank 1 | Rank 2 |

| | | | |
|---|---|---|---|
| Subband 1 | 1.0 | 0.8 | 1.0 |
| Subband 2 | 1.2 | 1.0 | 1.4 |
| Subband 3 | 0.4 | 0.8 | 0.5 |
| Subband 4 | 1.1 | 0.6 | 0.2 |
| Subband 5 | 2.5 | 0.7 | 0.7 |
| Subband 6 | 1.8 | 0.6 | 0.7 |
| Subband 7 | 0.9 | 0.4 | 0.3 |
| Subband 8 | 0.6 | 0.5 | 0.5 |

It is assumed that J is tour and M is two. Since M is smaller than J, the single rank is determined based on a sum of M metrics. The sum of two largest metric sums of rank 1 is 4.3 and the sum of two largest metric sums of rank 2 is 4.2. Accordingly, the single rank is determined as rank 2.

Hereinafter, specific examples are described to show advantages of the proposed method.

It is assumed that the mode is a multiple codeword mode, and C₁ of rank 1 is one, and C₂ of rank 2 is two. As MIMO scheme, cyclic delay diversity (CDD) is used for rank 1, and generalized CDD is used for rank 2. A receiver uses successive interference cancellation (SIC) as a receiving technique of rank 2. It is also assumed that the FFT size is 512, one subband includes 36 subcarriers and 10 OFDM symbols and there are eight subbands in total. 10 UEs are in a sector and scheduled by conventional proportional fair algorithm.

It is assumed that a CQI for one rank per subband is fed back. The rank of each subband can be differed.

### First Example

One subband is allocated to a UE and the UE feeds back a rank and a corresponding CQI for each subband. The BS informs the UE of information on resources allocated to each subband (MCS, MIMO scheme and the like).

CQIs measured by the UE for each rank are shown in Table 7 (the unit is decibel).

TABLE 7

| | |
|---|---|
| Rank 1 | Rank 2 |

| | | | |
|---|---|---|---|
| Subband 1 | 2.35 | 0.88 | 2.35 |
| Subband 2 | 3.66 | 2.35 | 4.85 |
| Subband 3 | −3.08 | 0.88 | −1.88 |
| Subband 4 | 3.02 | −0.85 | −6.55 |
| Subband 5 | 10.49 | 0.06 | 0.06 |
| Subband 6 | 7.03 | −0.85 | 0.06 |
| Subband 7 | 1.64 | −3.08 | −4.56 |
| Subband 8 | −0.85 | −1.88 | −1.88 |

If capacity f(SINR)=log(1+CQI) is used as a criterion, metrics calculated using the measured CQIs are shown in Table 8.

TABLE 8

| | |
|---|---|
| Rank 1 | Rank 2 |

| | | | |
|---|---|---|---|
| Subband 1 | 1.4 | 1.1 | 1.4 |
| Subband 2 | 1.7 | 1.5 | 2.0 |
| Subband 3 | 0.9 | 1.1 | 0.7 |
| Subband 4 | 1.6 | 0.8 | 0.3 |
| Subband 5 | 3.6 | 1.0 | 1.0 |
| Subband 6 | 2.6 | 0.8 | 1.0 |
| Subband 7 | 1.3 | 0.6 | 0.4 |
| Subband 8 | 0.8 | 0.7 | 0.7 |

In the case of subbands 1, 2, 3 or 8, since the sum of metrics of rank 2 is larger than the metric of rank 1, rank 2 is selected. In the case of subbands 4, 5, 6, or 7, since the sum of metrics of rank 2 is smaller than the metric of rank 1, rank 1 is selected. Since feedback information is rank information of each subband and a corresponding CQI, the UE feeds back channel information as shown in Table 9.

TABLE 9

| | |
|---|---|
| Rank information | CQI |

| | | | |
|---|---|---|---|
| Subband 1 | 2 | 0.88 | 2.35 |
| Subband 2 | 2 | 2.35 | 4.85 |
| Subband 3 | 2 | 0.88 | −1.88 |
| Subband 4 | 1 | 3.02 | |
| Subband 5 | 1 | 10.49 | |
| Subband 6 | 1 | 7.03 | |
| Subband 7 | 1 | 1.64 | |
| Subband 8 | 2 | −1.88 | −1.88 |

### Second Example

A plurality of subbands is allocated to a UE and the UE feeds back a rank of each subband and a corresponding CQI. The BS informs the UE of information on resources allocated to each subband (MCS, MIMO scheme and the like).

For clarity, CQIs and metrics of Tables 7 and 8 are used. Each UE feeds back the feedback information shown in Table 10.

TABLE 10

| | |
|---|---|
| Rank information | CQI |

| | | | |
|---|---|---|---|
| Subband 1 | 2 | 0.88 | 2.35 |
| Subband 2 | 2 | 2.35 | 4.85 |
| Subband 3 | 2 | 0.88 | −1.88 |
| Subband 4 | 1 | 3.02 | |
| Subband 5 | 1 | 10.49 | |
| Subband 6 | 1 | 7.03 | |
| Subband 7 | 1 | 1.64 | |
| Subband 8 | 2 | −1.88 | −1.88 |

This example is the same as the first example in that the UE reports all of the channel information of each subband. However, they are different in that only one subband is allocated to the UE in the first example, whereas a plurality of subbands is allocated to the UE in this example. Accordingly, downlink control information is reduced compared with the first example.

### Third Example

A plurality of subbands is allocated to a UE and the UE selects a single rank which is the rank having the largest value of the metric.

For clarity, CQIs and metrics of Tables 7 and 8 are used. Comparing a metric of rank 1 with a sum of metrics of rank 2 from subband 1 to subband 8, the metric of 3.6 of subband 5 is the largest (refer to mathematical expression 3). Accordingly, rank 1 is selected as the single rank. A corresponding CQI of each subband is fed back. Table 11 shows reported channel information.

TABLE 11
Rank information = Rank 1

| | CQI |
|---|---|
| Subband 1 | 2.35 |
| Subband 2 | 3.66 |
| Subband 3 | −3.08 |
| Subband 4 | 3.02 |
| Subband 5 | 10.49 |
| Subband 6 | 7.03 |
| Subband 7 | 1.64 |
| Subband 8 | −0.85 |

CQI values can be transmitted as they are, or a difference value from a previous value can be transmitted.

The UE reports the single rank and CQI of subbands for the single rank. Compared with the first example and the second example, the amount of radio resources for transmitting channel information is reduced.

### Fourth Example

A plurality of subbands is allocated to a UE and the UE selects a single rank based on a sum of J best subbands.

For clarity, CQIs and metrics of Tables 7 and 8 are used. It is assumed that J is four. Best subbands of rank 1 are in order of subbands 5, 6, 2, and 4, and the sum of their metrics is 9.6. Best subbands of rank 2 are in order of subbands 2, 1, 5, and 3, and the sum of their metrics is 9.8. Accordingly, rank 2 is selected as the single rank (refer to mathematical expression 5) and a corresponding CQI of each subband is fed back. Table 12 shows feedback information.

TABLE 12
Rank information = Rank 2

CQI

| | | |
|---|---|---|
| Subband 1 | 0.88 | 2.35 |
| Subband 2 | 2.35 | 4.85 |
| Subband 3 | 0.88 | −1.88 |
| Subband 4 | −0.85 | −6.55 |
| Subband 5 | 0.06 | 0.06 |
| Subband 6 | −0.85 | 0.06 |
| Subband 7 | −3.08 | −4.56 |
| Subband 8 | −1.88 | −1.88 |

The UE selects the single rank based on a sum of J best subbands and reports a CQI of the single rank. A plurality of subbands is allocated to each UE. Compared with the first example and second example, the amount of radio resources for transmitting channel information is reduced.

Table 13 shows spectral efficiencies of the examples described above.

TABLE 13

| | First | Second | Third | Fourth |
|---|---|---|---|---|
| | example | example | example | example |
| Spectral | 1.78 | 2.03 | 1.91 | 1.93 |
| efficiency | | | | |
| (bps/Hz/sector) | | | | |

Although the third and fourth examples nave a difference of about 6% in performance compared with the second example, the amount of reported channel information is small in the third and fourth examples. The amount of information on resource allocation informed by the BS to the UE is also small. The amount of the reported channel information is about (the number of subbands)×log₂(# of available ranks) bits in the first and second examples and about 1×log₂(# of available rinks) bits in the third and fourth examples.

Consequently, although a UE reports a single rank and a CQI for the single rank, the performance degradation does not occur. Signaling overhead can be minimized.

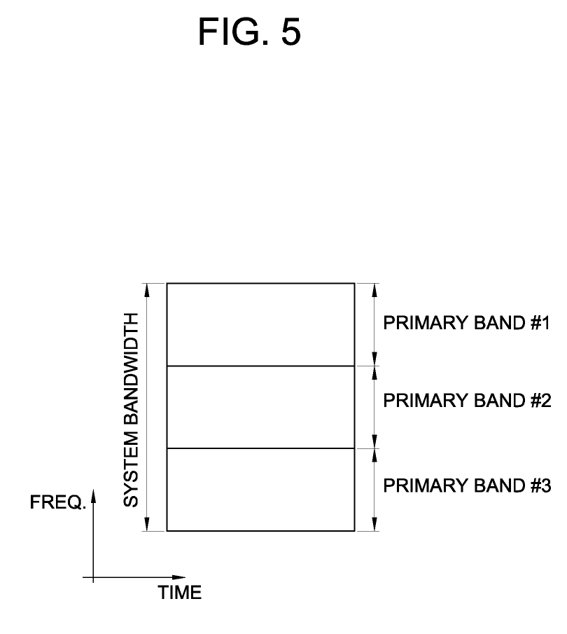

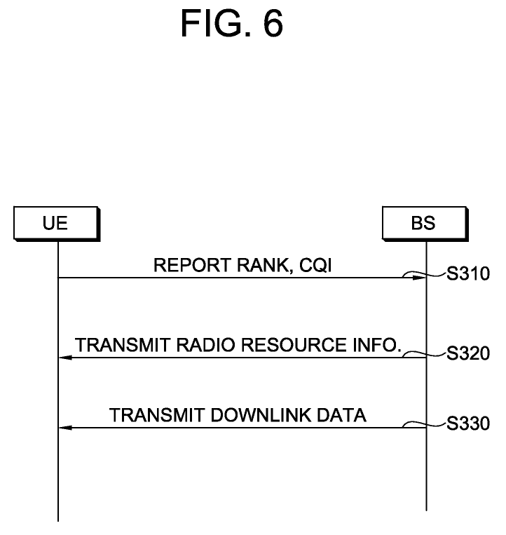

FIG. 5 is an exemplary view illustrating a method of reporting channel information according to an embodiment of the present invention.

Referring to FIG. 5, the system bandwidth is divided into a plurality of primary bands. A primary band has a bandwidth narrower than the system bandwidth and includes a plurality of subbands. When only a single rank is determined for the system bandwidth, efficiency can be lowered if the system bandwidth is large. For example, only a single rank can be selected in a system having a bandwidth of 5 MHz or smaller. In a system having a bandwidth of 5 MHz or larger, i.e., 10 MHz, 15 MHz, 20 MHz, or the like, the system bandwidth can be divided into a plurality of primary bands, and a single rank can be determined for each of the primary bands.

The number of primary bands can be differed depending on the size of the system bandwidth. The size of primary bands can be uniform or can be different with each other.

A UE selects a single rank for each of the primary bands and feeds back a CQI corresponding to the selected single rank. A BS transmits resource allocation information to the UE. The BS can transmit the resource allocation information through only one L1/L2 control signal.

In addition, the BS can allocate subbands having the same single rank to the UE. For example, it is assumed that a primary band #1 is determined as rank 1, a primary band #2 is determined as rank 1 and a primary band #3 is determined as rank 2. The BS can allocate primary bands #1 and #2 having the same rank to the UE.

FIG. 6 is a flowchart illustrating a method for transmitting data according to an embodiment of the present invention.

Referring to FIG. 6, a UE determines a single rank for overall subbands and transmits channel information including the single rank and a CQI for each subband of the single rank S310. A CQI is reported for each subband and only the single rank is reported for overall subbands. Therefore, signaling overhead due to reporting channel information can be reduced.

A BS transmits radio resource information allocated to the UE S320. The radio resource information can be transmitted through a downlink control channel, such as a L1/L2 control channel, dedicated control channel or the like. The radio resource information includes a rank used for downlink data and information on the allocated subband. The BS can determine the rank to be used for transmitting the downlink data using the single rank and inform the UE of the determined rank through the downlink control channel. Alternatively, the BS can determine the rank by overriding the single rank.

The BS transmits downlink data to the UE through the allocated subband S330.

A user equipment selects a single rank for overall subbands based on a specific criterion and reports only the single rank. Radio resources required for reporting channel information can be reduced and signaling overheads can be minimized.

The steps of a method described in connection with the embodiments disclosed herein may be implemented by hardware, software or a combination thereof. The hardware may be implemented by an application specific integrated circuit (ASIC) that is designed to perform the above function, a digital signal processing (DSP), a programmable logic device (PLD), a field programmable gate array (FPGA), a processor, a controller, a microprocessor, the other electronic unit, or a combination thereof. A module for performing the above function may implement the software. The software may be stored in a memory unit and executed by a processor. The memory unit or the processor may employ a variety of means that is well known to those skilled in the art.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are intended to be embraced by the appended claims.

What is claimed is:

1. A method of reporting downlink channel information to a base station in a multiple antenna system, the method comprising:
reporting a single rank for overall subband, the overall subband comprising a plurality of subbands; and
reporting a CQI for the single rank for at least one subband.

2. The method of claim 1, wherein after selecting at least one subband among the plurality of subbands, the CQI for the selected subband is reported.

3. The method of claim 2, further comprising:
reporting an average CQI for the other subbands.

4. The method of claim 1, further comprising:
receiving a rank used for downlink data from the base station through a downlink control channel.

5. A method of reporting downlink channel information to a base station in a multiple antenna system, the method comprising:
selecting a single rank for overall subband, the overall subband comprising a plurality of subbands;
reporting the single rank; and
reporting a CQI for the single rank for each subband.

6. The method of claim 5, wherein selecting the single rank comprises
calculating an signal-to-interference plus noise ratio (SINR) for each subband;
calculating metrics for every ranks using the SINR; and
selecting the single rank to which a subband having the largest metric belongs.

7. The method of claim 6, wherein a metric is a throughput of each rank.

8. The method of claim 6, wherein a metric is a capacity of each rank.

9. A method for transmitting downlink data in a multiple antenna system, the method comprising:
receiving a single rank for overall subband;
receiving a CQI for the single rank;
transmitting a rank determined using the single rank through a downlink control channel;
allocating at least one subband using the rank and the CQI; and
transmitting the downlink data through the allocated subband.

10. The method of claim 9, wherein the subband includes twelve subcarriers.
